(19) United States
(12) Patent Application Publication
(10) Pub. No.: US 2025/0334418 A1
(43) Pub. Date: Oct. 30, 2025

(54) METHODS AND SYSTEMS FOR OPTIMAL VEHICLE ROUTING IN PARKING LOTS

(71) Applicants: Hyundai Motor Company, Seoul (KR); Kia Corporation, Seoul (KR)

(72) Inventor: Chi Hwan Kim, Seoul (KR)

(21) Appl. No.: 18/940,149

(22) Filed: Nov. 7, 2024

(30) Foreign Application Priority Data
Apr. 26, 2024 (KR) 10-2024-0055877

(51) Int. Cl. G01C 21/34

(52) U.S. Cl. CPC G01C 21/3492; G01C 21/3461

(57) ABSTRACT

A method for determining an optimal route for a vehicle may include: requesting a user to set a destination for the vehicle within a parking lot having one or more exits; setting the destination for the vehicle according to the user input; receiving exit information of the parking lot, control information within the parking lot, and traffic information on roads adjacent to each of the exits in the parking lot, from a server; deriving a first cost from the vehicle to each of the exits in the parking lot based on the exit information and the control information; deriving a second cost from each of the exits to the destination based on the traffic information; and generating an optimal route from the vehicle to the destination based on the first cost and the second cost.

### CROSS-REFERENCE TO RELATED APPLICATION(S)

This application claims under 35 U.S.C. § 119(a) the benefit of Korean Patent Application No. 10-2024-0055877 filed on Apr. 26, 2024 in the Korean Intellectual Property Office, the entire contents of which are incorporated herein by reference.

### BACKGROUND

### (a) Technical Field

The present disclosure relates to a method and system for determining an optimal route to a destination for a vehicle within a parking lot.

### (b) Description of the Related Art

Assuming a situation in which a destination for a vehicle is set within a parking lot, and a route is guided by a navigation system, when there are multiple exits in the parking lot, only costs such as a time required from a specific exit to the destination, traffic conditions, or the like, are considered when generating a route, and in general, a degree of congestion within the parking lot, the time required from the specific exit to the destination, or the like, are not considered.

However, in places such as large supermarkets or malls, where the parking lot is large and internal circulation is complex, when exiting, the cost to each of the exits, the traffic conditions on roads at each of the exits, or the like also have a significant impact on the time required to reach a final destination, so there is a demand for a navigation system that can guide a more optimized route by reflecting these factors.

### SUMMARY

An aspect of the present disclosure is to provide an optimal route from a location of a vehicle within a parking lot to a destination in consideration of a degree of congestion within the parking lot.

Another aspect of the present disclosure is to select an optimal exit that can be included in a route from a location of a vehicle within a parking lot to a destination, when there are multiple exits in the parking lot, in consideration of traffic conditions on roads adjacent to each of the exits.

In order to solve the above-described problems, an aspect of the present disclosure is to propose a method and system for determining an optimal route for a vehicle, including a route within a parking lot, through various embodiments.

According to an aspect of the present disclosure, a method for determining an optimal route for a vehicle may include: requesting, by a processor, a user to set a destination for the vehicle, for a vehicle within a parking lot having one or more exits according to user input; setting, by the processor, the destination for the vehicle according to the input of the user; receiving, by the processor from a server, exit information of the parking lot, control information within the parking lot, and traffic information on roads adjacent to each of the exits in the parking lot; deriving, by the processor, a first cost from the vehicle to each of the exits in the parking lot based on the exit information and the control information; deriving, by the processor, a second cost from each of the exits to the destination based on the traffic information; and generating, by the processor, an optimal route from the vehicle to the destination, based on the first cost and the second cost.

In an embodiment, the method may further include determining the optimal route to the user.

In an embodiment, the optimal route may be a route in which a sum of the first cost and the second cost is the lowest.

In an embodiment, the control information within the parking lot may include at least one of a time required to travel from a vehicle within the parking lot to each of the exits, a ratio of travelling vehicles to all vehicles within the parking lot, a parking surface occupancy rate, a parking surface occupancy change rate, or a degree of congestion at each of the exits within the parking lot.

In an embodiment, factors considered in deriving the first cost may include at least one of a straight-line distance from the vehicle to each of the exits and a distance along a travelling route, an expected time required from each of the exits to the destination, whether turning behavior is required, or a degree of internal congestion.

In an embodiment, factors considered in deriving the second cost may include traffic information on roads adjacent to each of the exits, a straight-line distance from each of the exits to the destination and a distance along the roads, an expected time required from each of the exits to the destination, whether turning behavior is required, expected fuel consumption, and a degree of inclination of the roads.

In an embodiment, the first cost and the second cost may be derived through a cost extraction model learned by a learning unit.

In an embodiment, the cost extraction model can be learned using data regarding an actual time required to exit for each of the exits.

In an embodiment, the parking lot may be provided in plural, and the cost extraction model may be generated and stored for each parking lot.

According to another aspect of the present disclosure, a system for determining an optimal route for a vehicle may include: a processor, and an input unit connected to the processor, wherein the processor may request a user to set a destination for the vehicle within a parking lot having one or more exits, when the destination is set according to the input of the user through the input unit, receive exit information of the parking lot, control information within the parking lot, and traffic information on roads adjacent to each of the exits in the parking lot, from a server, derive a first cost from the vehicle to each of the exits in the parking lot based on the exit information and the control information, derive a second cost from each of the exits to the destination based on the traffic information, and generate an optimal route from the vehicle to the destination based on the first cost and the second cost.

In an embodiment, the system may further include an output unit connected to the processor, and the processor may guide the user to the optimal route through the output unit.

In an embodiment, the optimal route may be a route in which a sum of the first cost and the second cost is the lowest.

In an embodiment, the control information within the parking lot may include at least one of a time required to travel from the vehicle within the parking lot to each of the exits, a ratio of travelling vehicles among all vehicles within the parking lot, a parking surface occupancy rate, a parking surface occupancy change rate, or a degree of congestion at each of the exits within the parking lot.

In an embodiment, factors considered in deriving the first cost may include at least one of a straight-line distance from the vehicle to each of the exits and a distance along a travelling route, an expected time required from each of the exits to the destination, whether turning behavior is required, or a degree of internal congestion.

In an embodiment, factors considered in deriving the second cost may include at least one of traffic information on roads adjacent to each of the exits, a straight-line distance from each of the exits and a distance along the roads, an expected time required from each of the exits to the destination, and whether turning behavior is required, expected fuel consumption, or a degree of inclination of the roads.

In an embodiment, the system may further include a learning unit connected to the processor, and the first cost and the second cost may be derived through a cost extraction model learned by the learning unit.

In an embodiment, the cost extraction model may be learned using data regarding an actual time required to exit for each of the exits.

In an embodiment, the system may further include a memory connected to the processor, and the parking lot may be provided in plural, and the processor may generate the cost extraction model for each parking lot and store the same in the memory.

A vehicle comprises a system for determining an optimal route for a vehicle including the above-described elements.

A non-transitory computer readable medium containing program instructions executed by a processor may include: program instructions that request a user to set a destination for the vehicle within a parking lot having one or more exits; program instructions that set the destination for the vehicle according to input of the user; program instructions that receive exit information of the parking lot, control information within the parking lot, and traffic information on roads adjacent to each of the exits in the parking lot; program instructions that derive a first cost from the vehicle to each of the exits in the parking lot based on the exit information and the control information; program instructions that derive a second cost from each of the exits to the destination based on the traffic information; and program instructions that generate an optimal route from the vehicle to the destination based on the first cost and the second cost.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a conceptual diagram schematically illustrating a system for determining an optimal route for a vehicle, including a route within a parking lot according to an embodiment of the present disclosure;

FIG. 2 illustrates the types of data that can be included in control information within a parking lot;

FIG. 3 is a flowchart of a method for determining an optimal route for a vehicle, including a route within a parking lot according to an embodiment of the present disclosure;

FIG. 4 is a diagram illustrating an example of a degree of congestion at each of the exits within a parking lot;

FIG. 5 is a diagram illustrating an example of a traffic situation on roads adjacent to each of the exits in a parking lot;

FIG. 6 is a diagram illustrating a route passing through each of the exits from a vehicle within a parking lot to a destination; and

FIG. 7 is a diagram illustrating an optimal route considering first and second costs.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

While the present disclosure may be modified in various ways and take on various alternative forms, specific embodiments thereof are illustrated in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and they should not be construed to have ideally or excessively formal meanings, unless clearly defined in the application.

In this specification, a vehicle refers to various vehicles travelling objects to be transported, such as people, animals, or goods, from a starting point to a destination. These vehicles are not limited to vehicles that run on roads or tracks.

In the present disclosure, through various embodiments, when a destination is set by a driver in a vehicle within a parking lot, by reflecting a route and a degree of congestion to each of the exits within the parking lot, traffic conditions on roads adjacent to each of the exits, and the like, a more optimized route from a location of the vehicle within the parking lot to a destination may be guided.

Hereinafter, embodiments of the present disclosure will be described in more detail with reference to the attached drawings.

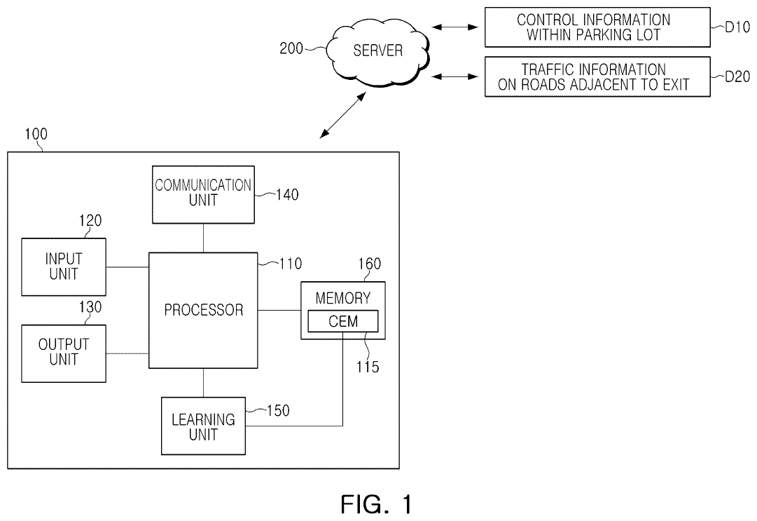

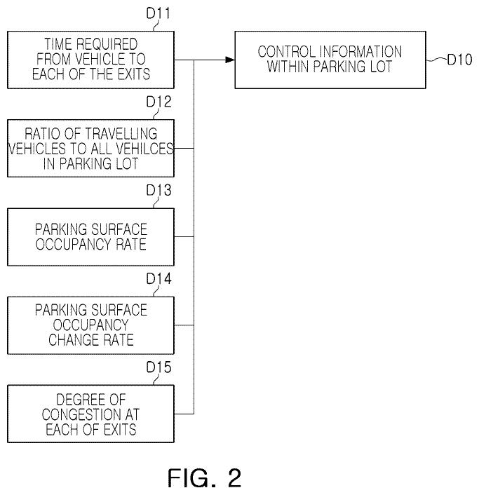

FIG. 1 is a conceptual diagram schematically illustrating a system for determining an optimal route for a vehicle, including a route within a parking lot according to an embodiment of the present disclosure. FIG. 2 illustrates the types of data that can be included in control information within a parking lot.

Referring to FIG. 1, a system for determining an optimal route for a vehicle, including a route within a parking lot 100 may include a processor 110 and an input unit 120, and may further include an output unit 130, a communication unit 140, a learning unit 150, and a memory 160. In addition, a cost extraction model (CEM) 115 stored in the memory 160 may extract first and second costs, to be described later, under the control of the processor 110, and may be learned by the learning unit 150.

The system for determining an optimal route for a vehicle, including a route within the parking lot 100 may receive control information D10 within the parking lot and/or traffic information D20 on roads adjacent to each of the exits in the parking lot, through a server 200. The system for determining an optimal route for a vehicle, including a route within the parking lot 100 in an embodiment may be configured to generate an optimal route from the vehicle within the parking lot to a destination set by a user based on received information and guide the user to the optimal route.

The processor 110 may be configured to control the input 120, the output unit 130, the communication unit 140, the learning unit 150, and the memory 160, and calculate a cost for determining an optimal route through the cost extraction model 115 stored in the memory 160 based on the control information D10 within the parking lot and the traffic information D20 on the roads adjacent to each of the exits in the parking lot received from the server 200. Here, the cost can be a criterion for determining route optimization, and the processor 110 may select a route in which the cost is the lowest, by quantifying the distance, cost, traffic situation, and whether turning behavior is required among various routes from a starting point to a destination as an optimal route.

The processor 110 of an embodiment may request the user to set a destination for the vehicle within a parking lot having one or more exits.

In addition, when the destination is set by a user through the input unit 120, the processor 110 may receive exit information of the parking lot and control information within the parking lot from the server 200, and derive a first cost from the vehicle to each of the exits in the parking lot based on the exit information and the control information.

In addition, the processor 110 may receive traffic information on roads adjacent to each of the exits in the parking lot from the server 200, and may derive a second cost from each of the exits in the parking lot to the destination set by the user based on the traffic information.

In addition, the processor 110 may generate an optimal route from the user vehicle within the parking lot to the destination set by the user based on the derived first and second costs.

In addition, the processor 110 may guide the user to the generated optimal route through the output unit 130.

Meanwhile, the processor 110 may be, for example, a central processing unit (CPU) or a semiconductor device processing instructions stored in the memory 160. The steps of the method or algorithm described in connection with embodiments of the present disclosure may be implemented directly in hardware, software modules, or a combination of the two executed by processor 110. The software module may be disposed in a storage medium such as RAM memory, flash memory, ROM memory, EPROM memory, EEPROM memory, registers, hard disk, solid state drive (SSD), removable disk, or CD-ROM. As an example, the storage medium may be coupled to a processor 110, and the processor 110 may read information from and write information to the storage medium. As another method, the storage medium may be integrated with the processor 110. The processor 110 and the storage medium may be disposed in an application specific integrated circuit (ASIC). The ASIC may be disposed in a user terminal. As another method, the processor 110 and the storage medium may be disposed as separate components within the user terminal.

The input unit 120 may be configured to receive input of a starting point, destination, and/or waypoint from the user.

The input unit 120 of an embodiment may be implemented as a jog dial or a touch pad that can input commands to move a cursor displayed on the output unit 130 and commands to select icons or buttons, and may include hardware devices such as various buttons, switches, pedals, keyboards, mice, track-balls, various levers, handles, sticks, and the like.

The input unit 120 of an embodiment may be implemented as a jog dial or a touch pad that can input commands to move a cursor displayed on the output unit 130 and commands to select icons or buttons, and include hardware devices such as various buttons, switches, pedals, keyboards, mice, track-balls, various levers, handles, sticks, and the like.

The output unit 130 may be configured to output an optimal route generated by calculating the cost for each route by the processor 110 on a display and guide the user to the optimal route.

The output unit 130 of an embodiment may be implemented with, for example, a Liquid Crystal Display (LCD) panel, an Electroluminescence (EL) panel, a Light Emitting Diode (LED) panel, an Organic Light Emitting Diode (OLED) panel, or the like, and may correspond to a cluster display disposed on a dashboard of a vehicle to display an image, or a head-up display projecting an image onto a windscreen, but the present disclosure is not limited thereto.

Meanwhile, the output unit 130 may be implemented as an integrated device having a mutual layer structure when the input unit 120 is implemented as a touch screen panel, but the present disclosure is not limited thereto.

The communication unit 140 may be configured to receive data regarding control information D10 within a parking lot and traffic information D20 on roads adjacent to each of the exits in the parking lot stored in a server 200, or transmit data such as location information, driving information, or the like, of the user vehicle to the server 200.

The communication unit 140 in an embodiment may include one or more components for communication between the system for determining an optimal route for a vehicle including a route within the parking lot 100 and the server 200, and for example, include a local area communication module and/or a wireless communication module.

The local area communication modules may include various local area communication modules transmitting and receiving signals using a wireless communication network within a near distance, such as a Bluetooth module, infrared communication module, Radio Frequency Identification (RFID) communication module, Wireless Local Access Network (WLAN) communication module, Near Field communication (NFC) module, Zigbee™ communication module, and the like. In addition, the wireless communication module may include a wireless communication module supporting various wireless communication methods such as Global System for Mobile Communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), Ultra Wide Band (UWB) module, and the like, in addition to Wi-Fi modules and Wi-Bro (Wireless broadband) modules, but the present disclosure is not limited thereto.

In order to increase accuracy when deriving the first cost and the second cost of the processor 110, the learning unit 150 may be configured to learn the cost extraction model 115 using an actual time required to exit as learning data in various situations, such as the location of the vehicle within the parking lot, time, congestion within the parking lot, the exit actually having passed through, and the like. The learned cost extraction model 115 may be stored in the memory 160 and executed by the processor 110, to derive the first cost from the vehicle within the parking lot to each exit and a second cost from each exit to a destination set by the user. Meanwhile, the cost extraction model 115 may be generated and stored for each parking lot in a plurality of parking lots, and can be used to determine an optimal route when departing from each parking lot.

Learning may be performed by the learning unit 150 in an embodiment in a manner in which the learning data is pre-processed so that it can be applied to the cost extraction model 115, and a loss function between a time required to exit, predicted by the cost extraction model 115 based thereon and an actual time required to exit is defined and the loss function is minimized through parameter adjustment, but the present disclosure is not limited thereto.

The memory 160 may be configured to receive control from the processor 110 and store the cost extraction model 115 for each parking lot generated by the processor 110.

The memory 160 in an embodiment may include at least one type of storage medium among, for example, a memory such as a flash memory type, a hard disk type, a micro type, and a card type (e.g., a Secure Digital Card (SD Card), an XD card, or the like, and a memory such as a Random Access Memory (RAM), static RAM (SRAM), Read-Only Memory (ROM), Programmable ROM (PROM), Electrically Erasable PROM (EEPROM), Magnetic RAM (MRAM), magnetic disk, and optical disk type memory, but the present disclosure is not limited thereto.

Referring to FIG. 1, the server 200 may be configured to receive and store data regarding the control information (D10) within the parking lot and data regarding the traffic information (D20) on roads adjacent to each of the exits in the parking lot, and transmit the data through the communication unit 140 of the system for determining an optimal route for a vehicle, including a route within the parking lot 100. Meanwhile, the server 200 may be configured to receive vehicle data such as a parked location of the user vehicle, driving information, and a time required from parking to exit.

The server 200 in an embodiment may transmit and receive data with the system for determining an optimal route for a vehicle, including a route within the parking lot 100, through a wireless network, a local area network, or the like.

Meanwhile, the server 200 may correspond to a Connected Car Service (CCS) server or an external server, but the present disclosure is not limited thereto.

The control information (D10) within the parking lot may include exit information of the parking lot in which the vehicle is parked, travelling information of the vehicle within the parking lot, and the like.

Referring to FIGS. 1 and 2, in the control information (D10) within the parking lot, at least one of a time required to travel from the vehicle within the parking lot to each of the exits (D1), a ratio of travelling vehicles to all vehicles within the parking lot (D2), a parking surface occupancy rate (D3), a parking surface occupancy change rate (D4), or a degree of congestion at each of the exits within the parking lot (D5) may be included.

Here, the parking space occupancy rate (D3) may refer to a ratio of parked vehicles to all parking spaces. The parking surface occupancy change rate (D4) may refer to a ratio at which the parking surface occupancy rate (D3) changes. For example, if both the parking surface occupancy rate (D3) and the parking surface occupancy change rate (D4) are high, it may be determined that the exit near that area in the parking has a high degree of congestion.

In addition, if there are multiple exits in the parking lot in which a user vehicle is parked, information such as the number of exits in the parking lot, a direction of the exits, a distance from the user vehicle to each of the exits, and the like, may be included in the control information (D10) within the parking lot, the present disclosure is not limited thereto.

Referring to FIG. 1, traffic information (D20) on roads adjacent to each of the exits in the parking lot may include traffic information on roads adjacent to each of the exits in the parking lot in which the user vehicle is parked. In other words, if there are multiple exits in the parking lot, real-time information such as traffic volume on adjacent roads, vehicle speed, accident occurrence, construction section, signal condition, and the like, including an exit route at each of the exits, may be included and stored in the server 200.

Meanwhile, the traffic information (D20) on the roads adjacent to each of the exits in the parking lot may be collected, for example, by a Transport Protocol Experts Group (TPEG), that is, a real-time traffic information service, where TPEG is a technical standard for transmitting traffic information using data transmission media such as terrestrial Digital Multimedia Broadcasting (DMB) and Digital Audio Broadcasting (DAB), and it is possible to provide more advanced services than existing services such as Radio Data System or FM Data Radio Channel (FM DARC) of FM broadcasting.

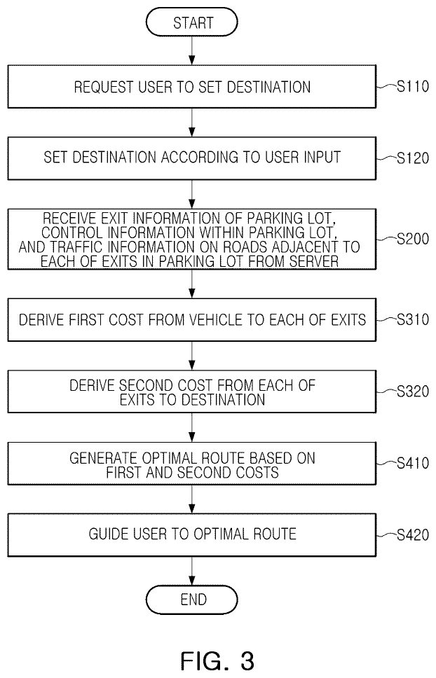

FIG. 3 is a flowchart of a method for determining an optimal route for a vehicle, including a route within a parking lot according to an embodiment of the present disclosure.

Referring to FIGS. 1 to 3, the processor 110 may first request a user to set a destination for the vehicle (S110).

Here, the user's vehicle may be parked on a parking surface within the parking lot or may be a vehicle driving in a route within the parking lot, and the destination may be any point outside the parking lot. In addition, the parking lot may have one or more exits.

Next, the processor 110 may set a destination of the vehicle according to user input (S120).

Meanwhile, the user may set the destination directly through the input unit 120 within the vehicle, but the present disclosure is not limited thereto, and may also set the destination through an app for a user terminal linked to the vehicle.

Next, the processor 110 may control the communication unit 140 to receive exit information of the parking lot in which the user vehicle is parked, control information within the parking lot, and traffic information on roads adjacent to each of the exits in the parking lot from the server 200 (S200).

Here, the exit information of the parking lot may include information such as the number of exits in the parking lot, a direction of the exits, a distance from the user vehicle to each of the exits, and the like.

In addition, the control information within the parking lot may include, for example, at least one of a time required to travel from the vehicle within the parking lot to each of the exits (D1), a ratio of travelling vehicles to all vehicles within the parking lot (D2), a parking surface occupancy rate (D3), a parking surface occupancy change rate (D4), or a degree of congestion at each of the exits within the parking lot (D5).

In addition, the traffic information on roads adjacent to each of the exits in the parking lot, when there are multiple exits in the parking lot in which the user vehicle is parked, may include, for example, at least one of real-time information such as traffic volume on adjacent roads, vehicle speed, accident occurrence, construction section, signal situation, or the like, including an exit route at each of the exits.

Next, the processor 110 may derive a first cost from the vehicle within the parking lot to each of the exits based on the exit information and the control information within the parking lot received from the server 200 (S310).

Here, factors considered in deriving the first cost may include a straight-line distance from the vehicle within the parking lot to each of the exits and a distance along a travelling route, an expected time required from each of the exits to the destination, whether turning behavior of the vehicle among routes to each of the exits is required, and a degree of congestion at each of the exits. The turning behavior of the vehicle may include left turns, right turns, and U-turns. For example, the first cost may be derived as a lower value, the shorter the distance from the vehicle within the parking lot to the each of the exits and expected required time, the fewer the number of turning behaviors required on a route to each of the exits, and the lower the degree of congestion at each of the exits.

Next, the processor 110 may derive a second cost from each exit to a destination for the vehicle set by the user based on traffic information on roads adjacent to each of the exits in the parking lot (S320).

Here, factors considered in deriving the second cost may include at least one of traffic information on roads adjacent to each of the exits in the parking lot, a straight-line distance from each of the exits to a destination for the vehicle set by the user and a distance along the roads, an expected time required from each of the exits to the destination, the number of turning behaviors of the vehicle required on that route, expected fuel consumption, or a degree of inclination of the road. The turning behavior of the vehicle may include left turns, right turns, U-turns, and the like. For example, the second cost may be derived as a lower value, the shorter the distance from each of the exits in the parking lot to the destination and expected required time required from each of the exits to the destination, the fewer number of turning behaviors required on the route, the lower the expected fuel consumption, and the lower the degree of inclination of the road included in the route, but the present disclosure is not limited thereto.

Meanwhile, the processor 110 may execute a cost extraction model 115 for deriving the first cost and the second cost stored in the memory 160, and control the learning unit 150 to learn the cost extraction model 115 using the actual time required to exit under various situations, such as the location of the vehicle within the parking lot, time, the degree of congestion within the parking lot, and the exit that has actually passed as learning data. For example, it can be used for model learning by assigning weights to data regarding an actual time for any car to be required to exit to the same exit at the same parking surface at a time similar to the exit time of the user's vehicle, and learning may be performed in a manner in which a loss function between an exit time predicted by the cost extraction model 115 and an actual exit time may be defined and the loss function may be minimized by adjusting parameters. Meanwhile, the cost extraction model 115 may be generated and stored for each parking lot in a plurality of parking lots, and may be used to determine the optimal route when departing from each parking lot.

Next, the processor 110 may generate an optimal route from the vehicle within the parking lot to the destination based on the derived first and second costs (S410).

As an example, the processor 110 may determine a route with the lowest sum of the first cost and the second cost as an optimal route among respective routes from the vehicle within the parking lot to the destination passing through each of the exits in the parking lot.

Next, the processor 110 may control the output unit 130 to guide the user to an optimal route from the vehicle within the parking lot to the destination generated based on the first cost and the second cost (S420). That is, the output unit 130 can guide the user to the optimal route by outputting the optimal route generated by the processor 110 by calculating the first and second costs for each route on a display of the vehicle.

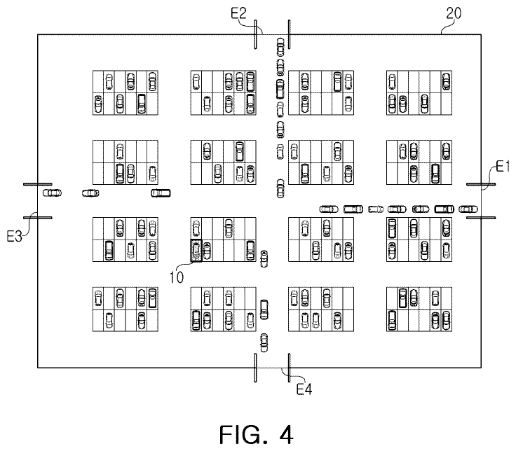

FIG. 4 is a diagram illustrating an example of a degree of congestion at each of the exits within a parking lot.

Referring to FIG. 4, the user vehicle 10 is parked on a specific parking surface within a parking lot 20, and the parking lot 20 may include a first exit E1 in an east direction, a second exit E2 in a north direction, a third exit E3 in a west direction, and a fourth exit E4 in a south direction. For example, considering the parking surface occupancy rate and the ratio of vehicles flowing through the passage within the parking lot 20 near the exit, it may be determined that the first exit E1 and the second exit E2 have a high degree of congestion, and the third exit E3 and the fourth exit E4 have a low degree of congestion.

Therefore, in the case of FIG. 4, it may be determined that the first cost from the vehicle 10 within the parking lot 20 to each exit E1, E2, E3, and E4 is high at the first exit E1 or the second exit E2, and is low at the third exit E3 or the fourth exit E4.

However, in order to generate an optimal route, since the road conditions not only within the parking lot 20 but also outside the parking lot 20 should be considered, hereinafter, traffic conditions on roads adjacent to an exit route at each of the exits in the parking lot 20 will be described.

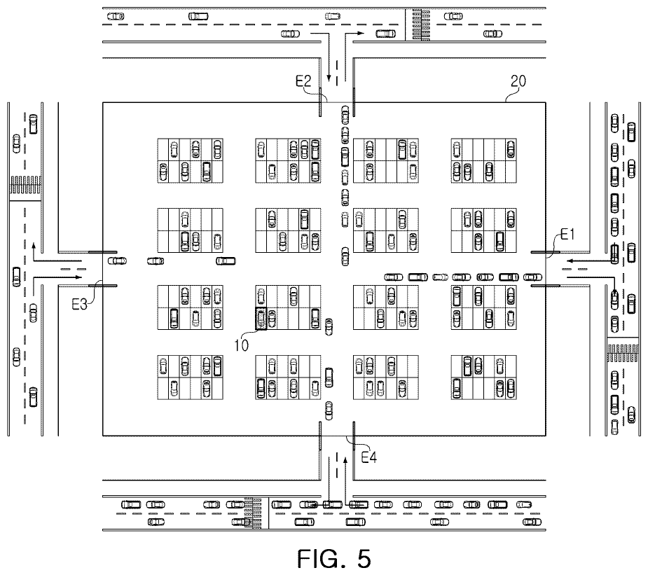

FIG. 5 is a diagram illustrating an example of a traffic situation on a road adjacent to each exit from a parking lot.

Referring to FIG. 5, the user vehicle 10 may be parked on a specific parking surface in a parking lot 20, and the parking lot 20 may include a first exit E1 in an east direction, a second exit E2 in a north direction, a third exit E3 in a west direction, and a fourth exit E4 in a south direction.

If a degree of congestion within the parking lot 20 is high and a flow of traffic on the road adjacent to the parking lot 20 is smooth, the optimal route may be to exit to one of the third exit E3 or the fourth exit E4, which are the exits closest to the user's vehicle 10, and to use external roads for the remaining route.

In addition, if the degree of congestion within the parking lot 20 is high and a flow of traffic within the parking lot 20 is low and the flow of traffic on the road adjacent to the parking lot 20 is congested, in order to move as much as possible in the parking lot 20, the optimal route may be to use an exit closest the destination and minimize the use of external roads.

However, as shown in FIG. 5, if the traffic conditions on the adjacent roads are different at each of the exits in the parking lot 20, in order to find an optimized route, not only a first cost related to the movement within the parking lot 20 but also a second cost depending on the traffic conditions on the roads adjacent to each of the exits should be considered. As an example, referring to FIG. 5, the degree of congestion within the parking lot 20 is high at the first exit E1 or the second exit E2, and low at the third exit E3 or the fourth exit E4, and the degree of congestion of the roads adjacent to each of the exits E1, E2, E3, and E4 may be determined to be high at the first exit E1 or the fourth exit E4 and low at the second exit E2 or the third exit E3.

In this case, by the method for determining an optimal route for a vehicle, including the route within the parking lot, an optimal route may be determined by considering a first cost related to movement within of the parking lot and a second cost related to movement outside of the parking lot, among various routes passing through each of the exits E1, E2, E3, and E4.

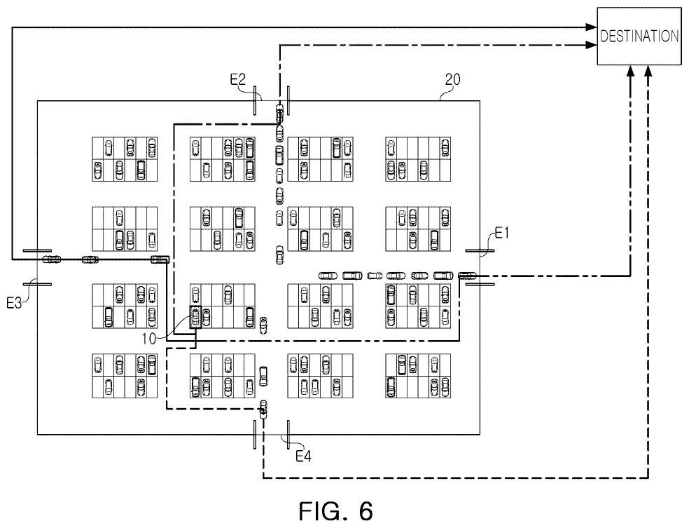

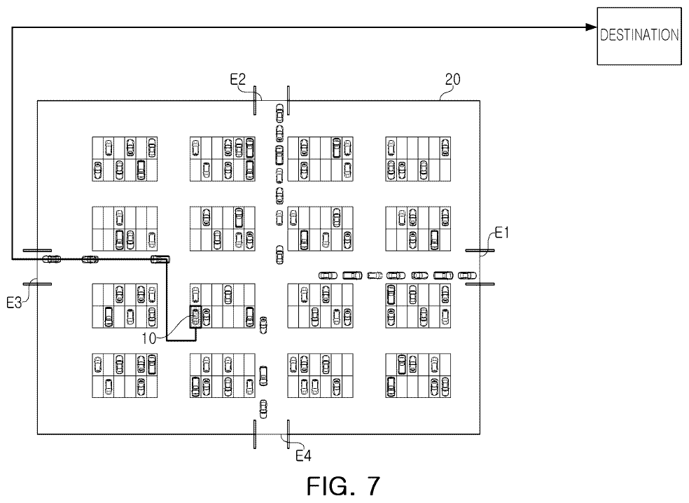

FIG. 6 is a diagram illustrating a route passing through each exit from a vehicle in a parking lot to a destination. FIG. 7 is a diagram illustrating an optimal route considering first and second costs.

Referring to FIGS. 5 and 6, as an example, a total of four routes that can pass through a total of four exits E1, E2, E3, and E4, from the user vehicle 10 in the parking lot 20 to a destination, may be generated. The exit with the minimum distance from the parking lot 20 to the destination may be a first exit E1 or a second exit E2, but the first exit E1 and the second exit E2 have a lot of traffic and high congestion in the parking lot, so a first cost from the vehicle 10 to each of the exits E1, E2, E3, and E4 may be high at the first exit E1 or the second exit E2, and may be low at the third exit E3 or the fourth exit E4.

However, as seen in FIG. 5, a second cost reflecting traffic conditions on roads adjacent to each of the exits E1, E2, E3, and E4 may be high at the first exit E1 or the fourth exit E4, and low at the second exit E2 or the third exit E3.

Therefore, referring to FIG. 7, assuming that other variables are the same, among the four routes passing through each exit E1, E2, E3, and E4 from the vehicle 10 in the parking lot 20 to the destination, a route with the lowest sum of the first cost and the second cost may be determined as a route passing through a third exit E3.

As seen above, when generating a route from a vehicle in a parking lot to a destination by the method and system for determining an optimal route for a vehicle, including a route within a parking lot according to embodiments of the present disclosure, by considering costs of inner and outer regions, adjacent to each of the exits in the parking lot, a more efficient and accurate optimal route may be guided to a user.

As set forth above, according to an aspect of the present disclosure, when generating a route for a vehicle, by reflecting a degree of congestion within a parking lot, a more optimized route may be provided from a location of the vehicle within the parking lot to a destination.

According to another aspect of the present disclosure, when there are multiple exits in a parking lot, by reflecting traffic conditions on roads adjacent to each of the exits, an optimal exit to be included in the more optimized route from the location of the vehicle within the parking lot to the destination may be selected.

The present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes would be obvious to those of ordinary skill in the art.

What is claimed is:

1. A method for determining an optimal route for a vehicle, comprising:
requesting, by a processor, a user to set a destination for the vehicle within a parking lot having one or more exits;
setting, by the processor, the destination for the vehicle according to input of the user;
receiving, by the processor from a server, exit information of the parking lot, control information within the parking lot, and traffic information on roads adjacent to each of the exits in the parking lot;
deriving, by the processor, a first cost from the vehicle to each of the exits in the parking lot based on the exit information and the control information;
deriving, by the processor, a second cost from each of the exits to the destination based on the traffic information; and
generating, by the processor, an optimal route from the vehicle to the destination based on the first cost and the second cost.

2. The method of claim 1, further comprising:
guiding the user to the optimal route.

3. The method of claim 1, wherein the optimal route is a route in which a sum of the first cost and the second cost is the lowest.

4. The method of claim 1, wherein the control information within the parking lot comprises at least one of a time required to travel from the vehicle within the parking lot to each of the exits, a ratio of travelling vehicles to all vehicles within the parking lot, a parking space occupancy rate, a parking space occupancy change rate, or a degree of congestion at each of the exits within the parking lot.

5. The method of claim 1, wherein factors considered in deriving the first cost comprise at least one of a straight-line distance from the vehicle to each of the exits and a distance along a travelling route, an expected time required from each of the exits to the destination, whether turning behavior is required, or a degree of internal congestion.

6. The method of claim 1, wherein factors considered in deriving the second cost comprise at least one of traffic information on roads adjacent to each of the exits, a straight-line distance from each of the exits to the destination and a distance along the roads, an expected time required from each of the exits to the destination, whether turning behavior is required, expected fuel consumption, or a degree of inclination of the roads.

7. The method of claim 1, wherein the first cost and the second cost are derived through a cost extraction model learned by a learning unit.

8. The method of claim 7, wherein the cost extraction model is learned using data regarding an actual time required to exit for each of the exits.

9. The method of claim 7, wherein the parking lot is provided in plural, and the cost extraction model is generated and stored for each parking lot.

10. A system for determining an optimal route for a vehicle, comprising:
a processor; and
an input unit connected to the processor,
wherein the processor is configured to:
request a user to set a destination for the vehicle for a vehicle within a parking lot having one or more exits,
when the destination is set according to input of the user through the input unit, receive exit information of the parking lot, control information within the parking lot, and traffic information on roads adjacent to each of the exits in the parking lot, from a server,
derive a first cost from the vehicle to each of the exits in the parking lot based on the exit information and the control information,
derive a second cost from each of the exits to the destination based on the traffic information, and
generate an optimal route from the vehicle to the destination based on the first cost and the second cost.

11. The system of claim 10, further comprising:
an output unit connected to the processor,
wherein the processor guides the user to the optimal route through the output unit.

12. The system of claim 10, wherein the optimal route is a route in which a sum of the first cost and the second cost is the lowest.

13. The system of claim 10, wherein the control information within the parking lot comprises at least one of a time required to travel from a vehicle within the parking lot to each of the exits, a ratio of travelling vehicles among all vehicles within the parking lot, a parking surface occupancy rate, a parking surface occupancy change rate, or a degree of congestion for each of the exits within the parking lot.

14. The system of claim 10, wherein factors considered in driving the first cost comprises at least one of a straight-line distance from the vehicle to each of the exits and a distance along a travelling route, an expected required time required from each of the exits to the destination, whether turning behavior is required, or a degree of internal congestion.

15. The system of claim 10, wherein factors considered in driving the second cost comprises at least one of traffic information on roads adjacent to each of the exits, a straight-line distance from each of the exits to the destination and a distance along the roads, an expected time required from each of the exits to the destination, whether turning behavior is required, expected fuel consumption, or a degree of inclination of the roads.

16. The system of claim 10, further comprising:
a learning unit connected to the processor,
wherein the first cost and the second cost are derived by a cost extraction model learned by the learning unit.

17. The system of claim 16, wherein the cost extraction model is learned using data regarding an actual time required to exit for each of the exits.

18. The system of claim 16, further comprising:
a memory connected to the processor,
wherein the parking lot is provided in plural, and the processor generates the cost extraction model for each parking lot and stores the same in the memory.

19. A vehicle comprising the system of claim 10.

20. A non-transitory computer readable medium containing program instructions executed by a processor, the computer readable medium comprising:
program instructions that request a user to set a destination for the vehicle within a parking lot having one or more exits;
program instructions that set the destination for the vehicle according to input of the user;
program instructions that receive exit information of the parking lot, control information within the parking lot, and traffic information on roads adjacent to each of the exits in the parking lot;
program instructions that derive a first cost from the vehicle to each of the exits in the parking lot based on the exit information and the control information;
program instructions that derive a second cost from each of the exits to the destination based on the traffic information; and
program instructions that generate an optimal route from the vehicle to the destination based on the first cost and the second cost.
